(19) United States
(12) Patent Application Publication
(10) Pub. No.: US 2008/0257381 A1
(43) Pub. Date: Oct. 23, 2008

(54) Use of Polyvinyl Acetate Dispersions for Cleaning Purposes

(76) Inventors: Klaus Winterscheidt, Bargteheide (DE); Heidrun Winterscheidt, Bargteheide (DE)

Correspondence Address: WOLF GREENFIELD & SACKS, P.C., 600 ATLANTIC AVENUE, BOSTON, MA, 02210-2206, US

(21) Appl. No.: 11/664,762

(22) PCT Filed: Oct. 4, 2005
(86) PCT No.: PCT/EP05/10677

§ 371 Date: Jun. 6, 2008

(30) Foreign Application Priority Data
Oct. 7, 2004 (DE) 102004048851.7

(51) Int. Cl. B08B 7/00

(52) U.S. Cl. 134/4

(57) ABSTRACT

The invention relates to the use of dispersions containing polyvinyl acetate for cleaning purposes, for example for cleaning plaster floors, ceramic wall and floor linings, steps, window sills, gravestones, sculptures, and jointing materials. According to the invention, the dispersion containing polyvinyl acetate is applied to part or all of the surface to be cleaned. Once said layer has dried through, it can be removed from the surface to be cleaned in the form of a film. The dispersion forms a solid composite with the impurities, such that the impurities can also be removed with the film.

This invention relates to the particular use of conventional dispersions containing polyvinyl acetate for cleaning purposes.

Dispersions containing polyvinyl acetate (hereinafter PVAC dispersions) have been known for a long time and are commercially available on the market in a wide range. PVAC dispersions of this kind are used exclusively as adhesives. Adhesives of this kind are used in particular for the permanent bonding of materials in the paper and cardboard processing industries. Following processing, PVAC dispersions dry to form a film. They are in particular characterised by their ageing resistance and permanent flexibility and are therefore used especially for the adhesive binding of books and blocks.

The construction and art sector employ an extremely wide variety of artificial and natural stones or metals to produce, for example, stairs, window sills, floor linings, facades of all kinds or plasters on house walls. Materials of this kind are also used for gravestones or sculptures. In particular objects and materials exposed to weathering become very contaminated necessitating regular cleaning.

At present, there are various possibilities for removing impurities from materials of this kind. Conventionally, the contamination is softened by means of a cleaning fluid and removed mechanically, for example by brushing or scrubbing. However, the cleaning requires a relatively hard effort and impurities cannot always be completely removed and adhere in particular in capillaries, cracks or uneven, rough substrates. In addition, for example in the case of tiles bonded by joints, it is not always possible to clean both the tiles and the joints at the same time.

Another cleaning method consists in high-pressure cleaning using water and optionally other cleaning additives.

However, cleaning of this kind under high pressure cannot be used in interior spaces or can only be used with a significant effort. Moreover, the high pressure represents a considerable mechanical stress for the surface to be cleaned, wherein in particular there is a risk of the jointing material being damaged.

Finally, a further cleaning method consists in the use of conventional steam cleaning equipment. The use of such steam cleaners is extremely time-consuming. Moreover, the systems used are not always easy to use and the result of the cleaning is not always satisfactory. In addition, cleaning using steam cannot be used with all surfaces.

Dry ice cleaning is a relatively new method, but because of the high costs it can only be used with a few materials. Dry ice cleaning also entails the risk of the material to be cleaned being damaged due to the extreme temperature differences.

Therefore, the object of the invention consists in disclosing a means with which surfaces of the type mentioned in the introduction can be cleaned particularly favourably and in a simple way.

According to the invention, the object is achieved by the use of dispersions containing PVAC for cleaning purposes comprising PVAC and at least one solvent.

The invention means it is possible with a low effort and inexpensively to remove contamination of all kinds, for example including lichen, moss or fungus, with no residue.

The following materials, surfaces or objects can be cleaned with the PVAC dispersion: screed floors, ceramic wall and floor linings, stairs, window sills, gravestones and sculptures made of artificial or natural stone such as marble, granite, slate, open and closed-pore ceramic tiles, tile joints based on mineral and synthetic resins, faced and fair-faced masonry and facades made, for example, of clinker or brick, mineral and synthetic resin plasters in interior and outdoor areas and objects and works of art made of metal, wherein it is irrelevant whether these are varnished or not.

Because the PVAC dispersion, which is not necessarily mixed with other additives, is pH neutral and no additional mechanical treatment is required, it is also possible to clean valuable sculptures or monuments using the PVAC dispersion, since they are not mechanically or chemically changed or attacked.

The at least one solvent used in the PVAC dispersion is preferably water, wherein in addition to or in place of water, it is also possible to use volatile solvents or mixtures thereof, preferably a low alcohol such as for example methanol or ethanol. Particularly preferably, the PVAC dispersion is mixed with suitable additives such as aromatic substances or dyestuffs, natural or synthetic fibres or even weak acids, such as, for example, acetic acid or citric acid or mixtures thereof. The acids named are preferably used for adjusting the pH. It is, therefore, possible, for example, to remove lime bloom on masonry or lime deposits on objects of everyday use. The addition of a compound containing halogen such as, for example, chlorine dioxide or another suitable substance can also achieve a disinfecting action, which is of particular interest in the medical field.

As already mentioned, PVAC dispersions as adhesive materials are commercially available on the market. These dispersions can be used with a wide variety of viscosities, wherein it is recommended that a highly viscous dispersion be used if the surface to be cleaned is a vertical surface such as, for example, a sculpture or a house wall. For use on surfaces with a horizontal disposal, such as, for example, screed floors or floors made of tiles and jointing material and particularly when the surface has irregularities and indentations, the PVAC dispersion can have a lower viscosity.

Depending upon the material to be cleaned and the viscosity of the PVAC dispersion, it may be applied by a variety of methods, for example with a brush, a spatula, rubber squeegee or by spraying.

No complicated equipment is required to apply the PVAC dispersion.

The PVAC dispersion, optionally modified by additives, is applied in a thickness of 1.0 to 5.0 mm to the surface to be cleaned. Depending upon the solids content, after drying, this results in a film of from 0.5 to 2.5 mm thick. The PVAC dispersion is able to coat not only the surface of the material to be cleaned, but also to penetrate interspaces, indentations, pores and fine channels. The dispersion is able to penetrate impurities and/or deposits and to soften them.

In the case of metals susceptible to oxidation, such as, for example, iron, during the time between the application and the drying of the PVAC dispersion, a desired oxidation process takes place.

The dispersion applied is dried by the evaporation of the solvent, following which the PVAC dispersion forms a flexible film. A solid bond is formed between the dirt particles, and, in the case of metal, between the oxidation product and the flexible film formed, which after drying can be simply pulled off the surface to be cleaned.

The tear strength of this film can be improved by adding synthetic and/or natural fibres, for example, to the PVAC dispersion.

The time required for the PVAC dispersion to dry is obviously dependent upon the ambient temperature, the atmospheric humidity, the water absorptive capacity of the surface to be cleaned and the application thickness. The solvent also has an influence on the evaporation rate. The drying can be speeded up by heating the surface provided with the PVAC dispersion by radiant heaters, for example infrared radiators. If a floor surface with underfloor heating is to be cleaned, this can also shorten the drying process. The same applies to wall heating. When transportable objects, such as, for example, sculptures, are to be cleaned, stationary high-frequency radiators can be used.

It is also possible to place an industrial paper or industrial fabric, for example, nonwovens or gauze on a surface covered with the still undried PVAC dispersion. This will accelerate the drying process because the dispersing agent in the PVAC dispersion is provided with an additional evaporative surface.

The use of these industrial fabrics or industrial papers also has the advantage that it is easier to pull off the dried film since the tear strength is increased.

After the end of the drying process, the flexible film is simply pulled off together with the impurities adhering thereto. Any remnants of the film still remaining on the cleaned surfaces can be simply removed by means of water.

All the above-named equipment used for application can be cleaned without problem with water even if the dispersion has already hardened, for example, on a brush.

The use of the commercially available PVAC dispersions containing water as a dispersing agent involves particularly environmentally friendly substances, which simultaneously achieve a high cleaning efficiency. The simplicity of the performance of the cleaning according to this invention is also demonstrated by the fact that it is not necessary to wear protective clothing, for example, rubber gloves. The film pulled off can be disposed of in domestic refuse without any problems for the environment.

According to the invention, a method for cleaning surfaces made of the aforementioned materials is also proposed, wherein the above-described PVAC-containing dispersion is applied to a surface to be cleaned, the film obtained after the drying is pulled off together with the impurities and optionally further cleaning is performed.

According to a preferred method of this invention, it is also possible to apply the PVAC dispersion described as a base coat on the surface to be cleaned, leave it to dry and then apply a further layer as a top coat. The application of the top coat means the base coat can be applied in a lower thickness than would be possible when this PVAC dispersion is applied as a single layer on the surface to be cleaned.

Normally, as described above, the PVAC dispersion is applied as a single layer in a thickness of approximately 1.0 to 5.0 mm. After drying, depending upon the solids content, this produces a film with a thickness of approximately 0.5 to 2.5 mm.

After the application of the PVAC dispersion as a single layer, the drying time, which is dependent upon the above-mentioned factors, can take up to 24 h, wherein, after this period, the film is completely dry and can be removed in the form of a film.

If the PVAC dispersion is applied as a base coat and above this the top coat, it is completely adequate to apply the base coat in a lower thickness. For the desired cleaning effect, it is sufficient for the dried film of the base coat to have a thickness of less than 1.0 mm, preferably 0.1 to 0.5 mm. If the PVAC layer is applied as a base coat, the top coat is applied as soon as the surface of the base coat has dried. This is the case approximately 30 to 60 minutes after the application of the base coat. Therefore, reducing the application thickness of the base coat can significantly reduce the drying time.

The top coat forms an inseparable bond with the base coat and endows this with the strength required for the pulling-off so that both layers can be removed as a so-called bond together with the impurities in one process.

The materials which can be used for the top coat are usual adhesives which are also available on the market, for example hot melts, animal glue, contact adhesives and hot melt adhesives, reactive adhesives, solvent adhesives or dispersion adhesives which are known per se and which each contain polyurethane (hereinafter PUR) as the main adhesive.

The relevant type of adhesive is applied by means of the method most suitable therefore to the surface of the entire base coat comprising an already dried PVAC dispersion. For example, top coats comprising hot melts, in particular ethylene vinyl acetate (EVA), heat-sealing adhesives or PUR hot melt adhesives can be applied to the dried PVAC dispersion by means of a hot melt gun or spraying and animal glues by using rollers for hot setting adhesives. The application of reactive adhesives, solvent adhesives and dispersion adhesives containing polyurethane as the main adhesive and contact adhesives to the dried PVAC-dispersion undercoat is performed with rubber squeegees, brushes, swabs, glue guns, surface rollers or by spraying.

A further possibility for providing a base coat comprising a dried PVAC dispersion with a top coat consists in the heat-sealing method. A suitable industrial paper, which is provided with a thin layer of the PVAC dispersion or another thermoactive hot-melt adhesive is applied to the base coat comprising the PVAC dispersion. This takes advantage of the ability of thermoactive adhesives to reactivate their adhesive properties after drying on heat application. The coated material and the base coat are firmly bonded to each other by means of heat application, for example, by a hot-air gun, and pressure, for example, exerted by a rubber roller.

It is also possible to use commercially available adhesive-coated materials with permanent tack, ie polymer layers applied to film or paper, in particular acrylates and types of rubber. Here, following application to the dried PVAC dispersion, it is sufficient to rub briefly so that the base coat and top coat are bonded. In all the possible applications described, the base coat comprising the PVAC dispersion enters an inseparable bond with the top coat comprising another type of adhesive. Both layers can be pulled off together with the dirt adhering to the PVAC dispersion in one process. Therefore, this invention discloses a simple possibility for cleaning and optionally disinfecting surfaces of all types and made of numerous different materials, wherein a single application is generally sufficient. This invention can be used particularly advantageously in private households, but also in trade and commerce, in industry, for restoration purposes and in the medical field, for example for cleaning doctors' or veterinary practices.

The invention will now be explained in more detail with reference to the attached diagrams.

The diagrams show:

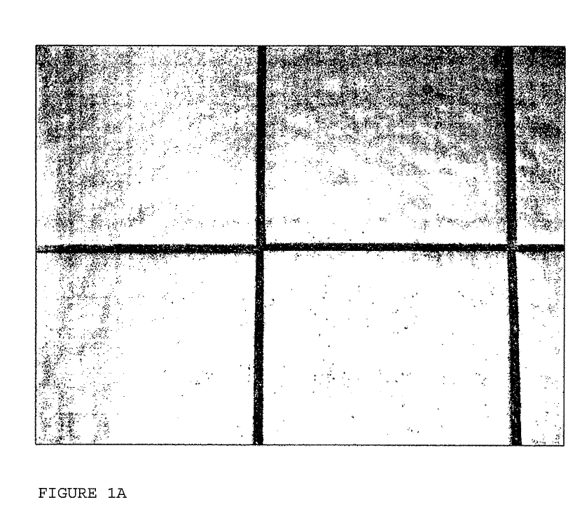

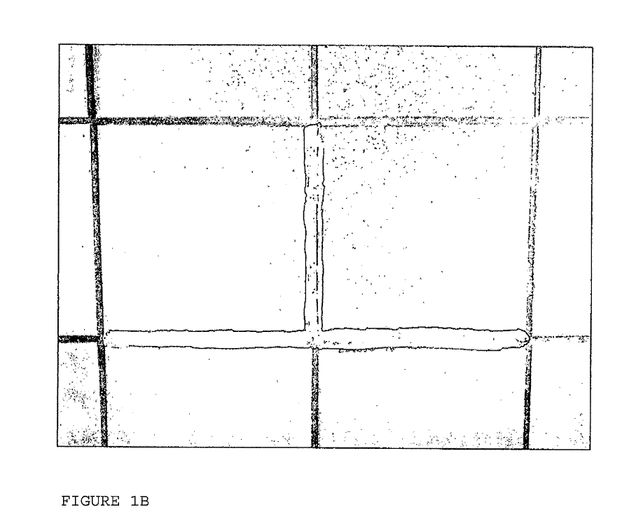

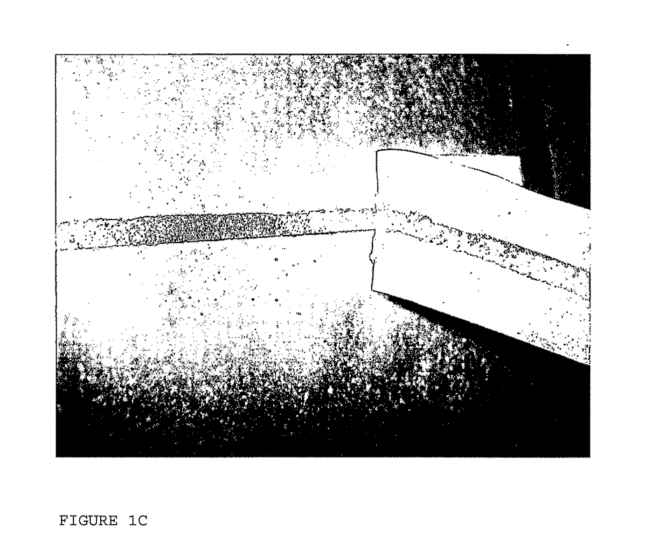

FIG. 1a a photograph of floor tiles and joints

FIG. 1b a photograph of floor tiles and joints with a support layer comprising the PVAC dispersion, which is only applied to the joints

FIG. 1c a photograph of floor tiles and joints with a support layer comprising the PVAC dispersion and a top coat comprising another type of adhesive, wherein these layers are only applied to the joints

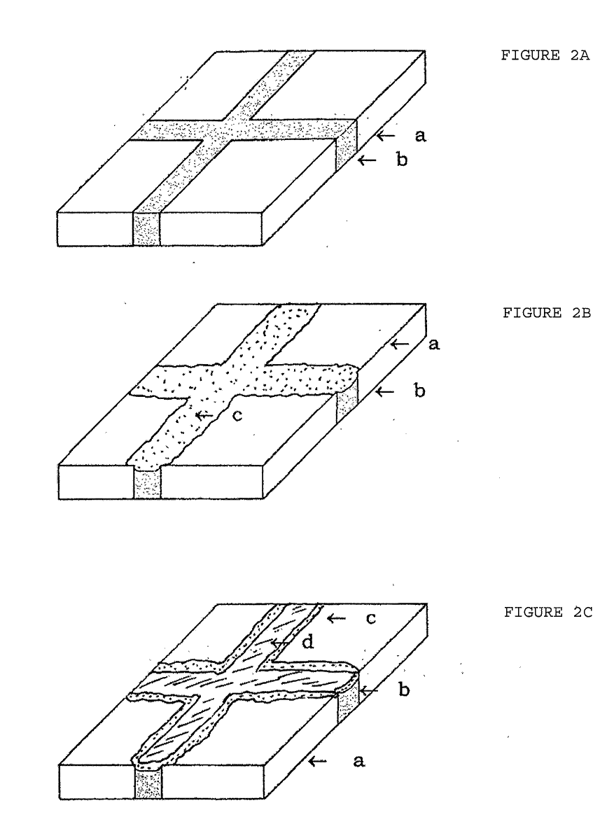

FIG. 2a a schematic representation of floor tiles and joints

FIG. 2b a schematic representation of floor tiles with a base coat comprising the PVAC dispersion applied to the joints only

FIG. 2c a schematic representation of floor tiles with a base coat comprising the PVAC dispersion applied to the joints and a top coat comprising another type of adhesive, and

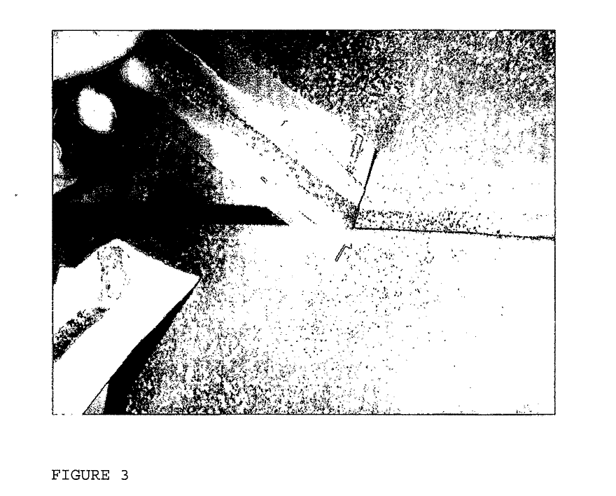

FIG. 3 a photograph of floor tiles with joints, wherein a double layer comprising the PVAC dispersion and an adhesive-coated film is applied to the joints

FIGS. 1a to 1c are photographs of floor tiles with joints. In FIG. 1a, the floor tiles and the jointing material are soiled as a result of use, but are not provided with a PVAC dispersion.

FIG. 1b shows the photograph according to FIG. 1a, wherein a base coat comprising the PVAC dispersion is applied to the joints. As FIG. 1c shows, an industrial paper can be placed on the still undried PVAC dispersion. The paper can be pressed with a foam roller or soft-rubber roller to produce a firm bond between the industrial paper and the PVAC dispersion.

FIG. 1c shows the bonded PVAC dispersion and industrial paper being pulled off. The photograph clearly shows the dirt adhering to the dried PVAC dispersion on the right and the clean joint on the left.

FIG. 2 is an illustration of conventional floor tiles (a) which are connected by means of conventional jointing material (b).

As shown in FIG. 2b, for cleaning for example the joints (b) of the floor tiles (a), the PVAC dispersion (c) is essentially only applied to the joints as a base coat. As described above, it may be applied using a variety of methods.

Then, as illustrated in FIG. 2c, a top coat (d) comprising another type of adhesive is applied to the already dried base coat comprising the PVAC dispersion as described above.

The base coat comprising the PVAC dispersion and the top coat comprising another type of adhesive form a solid bond. The dirt adhering to the PVAC dispersion is removed together with the bond.

As FIG. 3 shows, it is possible, for example to apply a base coat comprising the PVAC dispersion to floor tiles and/or tiles and leave this to dry. A paper or film coated with adhesive with a permanent tack is placed on top of this. Brief rubbing, for example, by means of a rubber roller, causes the PVAC dispersion and the material placed on top of this to form a solid bond. The dirt adhering to the PVAC dispersion is pulled off together with the bond.

With the embodiments described above with reference to all the diagrams, it is obviously possible to clean not only the jointing compound but also all the floor tiles together with the joints. Hereby, the PVAC dispersion, and optionally the further top coat, is applied over a large surface with a wiper or a brush. The jointing material can comprise all conventionally used materials, for example epoxy jointing compounds or cement mortar. The cleaning effect is the same in each case.

1. Method for cleaning surfaces or objects made of stone or metal materials or joints, characterised in that a polyvinyl-acetate-containing dispersion comprising at least one solvent is applied to the surface, object or joint to be cleaned as a base coat and a further layer is applied thereto as a top coat, wherein after the drying of these layers, a film forms which is pulled off the surface, object or joint together with impurities adherent thereto and the surface, object or joint are optionally subjected to other cleaning steps.

2. Method according to claim 1, characterised in that the dispersion contains water and/or at least one volatile solvent.

3. Method according to claim 1, characterised in that the dispersion contains further additives selected from natural fibres, synthetic fibres, acids, disinfectants, dyestuffs, aromatic substances or mixtures thereof.

4. Method according to claim 1, characterised in that the top coat contains an adhesive selected from hot melts, contact adhesives and hot melt adhesives, reactive adhesives, solvent adhesives or dispersion adhesives which are known per se and which each contain polyurethane (hereinafter PUR) as the main adhesive or animal glue or mixtures thereof.

5. Method according to claim 1, characterised in that ethylene vinyl acetate or polyurethane is applied to the base coat as a hot melt adhesive by means of a hot melt adhesive gun or spraying.

6. Method according to claim 1, characterised in that the top coat is applied by a heat-sealing method, wherein an industrial paper, which is provided with a thin layer of a polyvinyl-acetate-containing dispersion or another thermoactive hot-melt adhesive, is applied to the base coat a firm bond of the two layers is achieved by heat application and optionally pressure.

7. Method according to claim 1, characterised in that, following the application of the polyvinyl-acetate-containing dispersion and optionally the further layer, a drying process is performed.

8. Method according to claim 1, characterised in that, following the application of the polyvinyl-acetate-containing dispersion, the drying is performed by placing a paper, fabric, gauze or nonwoven on the layer.

9. Method according to claim 7, characterised in that a heating means is used for the drying.

10. Method according to claim 1, characterised in that the dispersion contains further additives selected from natural fibres, synthetic fibres, acids, disinfectants, dyestuffs, aromatic substances or mixtures thereof.

11. Method according to claim 1, characterised in that the top coat is formed from papers, fabrics, gauzes or nonwovens.

12. Method according to claim 1, characterised in that ceramic wall and/or floor linings, screed floors, window sills, gravestones, sculptures, tiles, faced and fair-faced masonry, clinker, bricks and/or plaster are cleaned.
